(19) United States
(12) Patent Application Publication
(10) Pub. No.: US 2025/0188280 A1
(43) Pub. Date: Jun. 12, 2025

(54) COMPOSITION AND FILM

(71) Applicant: FUJIFILM Corporation, Tokyo (JP)

(72) Inventors: Kana MUROI, Kanagawa (JP); Hirotaka KITAGAWA, Kanagawa (JP); Koji NAOE, Kanagawa (JP); Yasuyuki SASADA, Kanagawa (JP)

(73) Assignee: FUJIFILM Corporation, Tokyo (JP)

(21) Appl. No.: 19/057,940

(22) Filed: Feb. 19, 2025

Related U.S. Application Data
(63) Continuation of application No. PCT/JP2023/021604, filed on Jun. 9, 2023.

(30) Foreign Application Priority Data
Aug. 31, 2022 (JP) 2022-138489

(51) Int. Cl. C08L 77/12; C08G 63/60; C08G 63/80; C08G 63/83; C09D 7/20; C09D 7/40; C09D 7/65; C09D 177/12

(52) U.S. Cl. CPC C08L 77/12; C08G 63/605; C08G 63/80; C08G 63/83; C09D 7/20; C09D 7/65; C09D 7/66; C09D 177/12; C08L 2203/16; C08L 2203/206; C08L 2205/22

(57) ABSTRACT

A composition including thermoplastic particles having an average particle diameter of 100 μm or less, an aromatic polyester resin, and a solvent, and a film.

### CROSS-REFERENCE TO RELATED APPLICATION

This application is a continuation application of International Application No. PCT/JP2023/021604 filed Jun. 9, 2023, which claims priority from Japanese Patent Application No. 2022-138489, filed Aug. 31, 2022. The entire disclosure of each of the above applications is incorporated herein by reference.

### BACKGROUND OF THE INVENTION

### 1. Field of the Invention

The present disclosure relates to a composition and a film.

### 2. Description of the Related Art

In recent years, frequencies used in a communication equipment tend to be extremely high. In order to suppress transmission loss in a high frequency band, insulating materials used in a circuit board are required to have a lowered relative permittivity and a lowered dielectric loss tangent.

In addition, in the related art, polyimide is commonly used as the insulating material used in the circuit board, a liquid crystal polymer which has high heat resistance and low water absorption and is small in loss in the high frequency band has been attracted. In addition, in recent years, with the improvement of the performance of communication equipment, the size of blind vias and through-hole vias processed by multilayering or an UV laser has been reduced.

Therefore, the layer for following and adhering to the circuit board is required to have excellent level difference followability and excellent UV laser processing properties.

As a resin composition for following and adhering to a circuit board in the related art, for example, JP2019-199612A discloses a resin composition including a styrene-based polymer, an inorganic filler, and a curing agent, in which the styrene-based polymer is an acid-modified styrene-based polymer having a carboxyl group, the inorganic filler is silica and/or aluminum hydroxide, a particle diameter of the inorganic filler is 1 μm or less, a content of the inorganic filler is 20 to 80 parts by mass with respect to 100 parts by mass of the styrene-based polymer, and the resin composition satisfies Expression (A) and Expression (B) in a form of a film having a thickness of 25 μm.

X≤50 (A)

Y≥40 (B)

(In the expression, X represents an absorbance (unit: %) of light having a wavelength of 355 nm, and Y represents a haze value (unit: %).)

In addition, JP2022-17947A describes a thermosetting adhesive sheet including a binder resin and a curing agent, in which a cured product obtained by heating the thermosetting adhesive sheet at 180° C. for 1 hour satisfies (i) to (iv).
(i) In a case where the thickness of the cured product is 25 μm, the energy ray transmittance at a wavelength of 355 nm is 0% to 40%.
(ii) The relative permittivity is 1.5 to 3.0 at a frequency of 10 GHz and at 23° C.
(iii) The dielectric loss tangent is 0.0001 to 0.01 at a frequency of 10 GHz and at 23° C.
(iv) The linear expansion coefficient al at 0° C. to the glass transition temperature is 100 to 500 ppm/° C.

### SUMMARY OF THE INVENTION

An object to be achieved by an embodiment of the present disclosure is to provide a composition with which a film having excellent level difference followability and excellent laser processing suitability can be produced.

In addition, an object to be achieved by another embodiment of the present disclosure is to provide a film having excellent level difference followability and excellent laser processing suitability.

The means for achieving the above-described objects include the following aspects.

<1> A composition including: thermoplastic particles having an average particle diameter of 100 μm or less; an aromatic polyester resin; and a solvent.

<2> A composition including: thermoplastic particles; an aromatic polyester resin; and a solvent, in which a content of the thermoplastic particles is 50% by mass or more with respect to a total mass of solid contents contained in the composition.

<3> The composition according to <2>, in which a ratio of an average particle diameter of the thermoplastic particles to a thickness of a layer formed by a method of forming the following layer is 1.5 or less.

Method of forming layer: the composition is applied to a surface of a copper base material at a coating amount of 0.015 g/cm², and the composition is heated in an environment of 180° C. for 300 minutes to form a layer.

<4> The composition according to any one of <1> to <3>, in which the thermoplastic particles are elastomer particles.

<5> The composition according to any one of <1> to <4>, in which the thermoplastic particles contain a resin having a constitutional unit having an aromatic hydrocarbon group or an elastomer having a constitutional unit having an aromatic hydrocarbon group.

<6> The composition according to any one of <1> to <5>, in which the aromatic polyester resin contains an aromatic polyester amide.

<7> The composition according to any one of <1> to <6>, in which the solvent contains N-methylpyrrolidone.

<8> A film including: a layer A; and a layer B on at least one surface of the layer A, in which the layer B contains particles containing at least one of a resin having a constitutional unit having an aromatic hydrocarbon group or an elastomer having a constitutional unit having an aromatic hydrocarbon group, and an aromatic polyester resin, and a minimum area ratio of the particles in a cross section of the layer B in a thickness direction is 50% or more.

<9> The film according to <8>, in which a dielectric loss tangent at 28 GHz is 0.01 or less.

<10> The film according to <8> or <9>, in which a ratio of an elastic modulus of the layer A at 160° C. to an elastic modulus of the layer B at 160° C. is 1.2 or more.

<11> The film according to any one of <8> to <10>, in which an elastic modulus of the layer B at 160° C. is 10 MPa or less.

<12> The film according to any one of <8> to <11>, in which a dielectric loss tangent of the layer A at 28 GHz is 0.01 or less.

<13> The film according to any one of <8> to <12>, in which the layer A contains a liquid crystal polymer.

<14> The film according to any one of <8> to <13>, in which the layer A contains an aromatic polyester amide.

<15> The film according to any one of <8> to <14>, in which a dielectric loss tangent of the layer B at 28 GHz is 0.01 or less.

<16> The film according to any one of <8> to <15>, in which the layer B contains a liquid crystal polymer.

<17> The film according to any one of <8> to <16>, in which the aromatic polyester resin contains an aromatic polyester amide.

According to the embodiment of the present disclosure, it is possible to provide a composition with which a film having excellent level difference followability and excellent laser processing suitability can be manufactured.

In addition, according to another embodiment of the present disclosure, it is possible to provide a film having excellent level difference followability and excellent laser processing suitability.

### DESCRIPTION OF THE PREFERRED EMBODIMENTS

Hereinafter, the contents of the present disclosure will be described in detail. The description of configuration requirements below is made based on representative embodiments of the present disclosure in some cases, but the present disclosure is not limited to such embodiments.

Further, in the present specification, a numerical range shown using “to” indicates a range including numerical values described before and after “to” as a lower limit value and an upper limit value.

In a numerical range described in a stepwise manner in the present disclosure, an upper limit value or a lower limit value described in one numerical range may be replaced with an upper limit value or a lower limit value in another numerical range described in a stepwise manner. Further, in a numerical range described in the present disclosure, an upper limit value or a lower limit value described in the numerical range may be replaced with a value described in an example.

In the present disclosure, in a case where a plurality of substances corresponding to each component are contained in the composition, the amount of each component contained in the composition means the total amount of the plurality of substances, unless otherwise specified.

Further, in a case where substitution or unsubstitution is not noted in regard to the notation of a “group” (atomic group) in the present specification, the “group” includes not only a group that does not have a substituent but also a group having a substituent. For example, the concept of an “alkyl group” includes not only an alkyl group that does not have a substituent (unsubstituted alkyl group) but also an alkyl group having a substituent (substituted alkyl group).

In the present specification, “(meth)acryl” is a term that is used in a concept including both acrylic and methacryl.

Further, the term “step” in the present specification indicates not only an independent step but also a step which cannot be clearly distinguished from other steps as long as the intended purpose of the step is achieved.

Further, in the present disclosure, “% by mass” has the same definition as that for “% by weight”, and “part by mass” has the same definition as that for “part by weight”.

In the present disclosure, the term “solid content” means components excluding a solvent.

Furthermore, in the present disclosure, a combination of two or more preferred embodiments is a more preferred embodiment.

The “laser processing suitability” in the present disclosure is a characteristic in that excessive cutting by a laser can be reduced in a case where cutting processing by a laser, particularly through-hole processing is performed, and it can be said that the “laser processing suitability” is excellent in a case where the above-described characteristic is excellent, and the workability of a cutting portion in laser processing into a desired shape is excellent.

In the present disclosure, the “dielectric loss tangent” is measured by the following method.

The dielectric loss tangent is measured by a resonance perturbation method at a frequency of 28 GHz. A 28 GHz cavity resonator (CP531 manufactured by KANTO Electronic Application and Development Inc.) is connected to a network analyzer (“E8363B” manufactured by Agilent Technology Co., Ltd.), a test piece is inserted into the cavity resonator, and the dielectric loss tangent of the film is measured from change in resonance frequency before and after insertion for 96 hours under an environment of a temperature of 25° C. and humidity of 60% RH.

In a case of measuring the dielectric loss tangent of each layer, an unnecessary layer may be scraped off with a razor or the like to produce a sample for evaluation of only the target layer, and the sample may be used as a measurement target. In addition, in a case where it is difficult to take out the single film due to a reason such as a thin thickness of the layer, the layer to be measured may be scraped off with a razor or the like, and the obtained powdery sample may be used as a measurement target of the dielectric loss tangent.

In the present disclosure, the measurement of the dielectric loss tangent of the polymer is carried out according to the above-described measuring method of a dielectric loss tangent by identifying or isolating a chemical structure of the polymer constituting each layer and using a powdered sample of the polymer to be measured.

In addition, in the present disclosure, a weight-average molecular weight (Mw) is a molecular weight converted using polystyrene as a standard substance by performing detection with a gel permeation chromatography (GPC) analysis apparatus using TSKgel SuperHM-H (trade name, manufactured by Tosoh Corporation) column, a solvent of pentafluorophenol (PFP) and chloroform at a mass ratio of 1:2, and a differential refractometer, unless otherwise specified.

Hereinafter, the present disclosure will be described in detail.

### (Composition According to First Aspect)

A composition according to a first aspect (hereinafter, also referred to as a first composition) contains thermoplastic particles having an average particle diameter of 100 μm or less, an aromatic polyester resin, and a solvent.

From the viewpoint of coating properties and suppression of sedimentation of the thermoplastic particles, the viscosity of the first composition is preferably 50 mPa·s to 2,000 mPa·s, more preferably 100 mPa·s to 1,000 mPa·s, and still more preferably 200 mPa·s to 400 mPa·s.

In the present disclosure, the viscosity is measured at a rotation speed of 1000 (1/s) using a Rheometer (for example, HAAKE MARS, II manufactured by Thermo Fisher Scientific Inc.) while maintaining the temperature of the composition at 25° C.

### —Thermoplastic Particles—

From the viewpoint of dielectric loss tangent of the film, laser processing suitability, and level difference followability, the average particle diameter of the thermoplastic particles is preferably 1 μm to 100 μm, more preferably 1 μm to 60 μm, still more preferably 5 μm to 50 μm, particularly preferably 10 μm to 30 μm, and most preferably 10 μm to 20 μm.

In the present disclosure, the average particle diameter of the thermoplastic particles is intended to be a 50% volume cumulative diameter (D50). The average particle diameter is measured using a particle diameter analyzer (for example, “FPER-1000” manufactured by Otsuka Electronics Co., Ltd.).

The thermoplastic particles may be thermoplastic resin particles or elastomer particles.

From the viewpoint of dielectric loss tangent of the film, laser processing suitability, and level difference followability, the thermoplastic particles are preferably elastomer particles.

In the present disclosure, the elastomer represents a compound exhibiting elastic deformation. That is, the elastomer is defined as a compound having a property of being instantly deformed according to an external force in a case where the external force is applied and of being recovered to an original shape in a short time in a case where the external force is removed.

It is preferable that the elastomer has a property in which, in a case where the original size is 100%, the elastomer can be deformed up to 200% at room temperature (20° C.) with a small external force and the elastomer is returned to 110% or less in a short time in a case where the external force is removed.

In addition, from the viewpoint of dielectric loss tangent of the film, laser processing suitability, and level difference followability, the weight-average molecular weight of the elastomer constituting the elastomer particles or the thermoplastic resin constituting the thermoplastic resin particles is preferably 1,000,000 or less, more preferably 3,000 to 300,000, still more preferably 5,000 to 100,000, and particularly preferably 5,000 to 30,000.

The elastomer constituting elastomer particles is not particularly limited, and examples thereof include an elastomer having a constitutional repeating unit derived from styrene (that is, polystyrene-based elastomer), a polyester-based elastomer, a polyolefin-based elastomer, a polyurethane-based elastomer, a polyamide-based elastomer, a polyacryl-based elastomer, a silicone-based elastomer, and a polyimide-based elastomer. The thermoplastic elastomer may be a hydride.

Examples the polystyrene-based elastomer include a styrene-butadiene-styrene block copolymer (SBS), a styrene-isoprene-styrene block copolymer (SIS), a diblock copolymer polystyrene-poly(ethylene-propylene) (SEP), a polystyrene-poly(ethylene-propylene)-polystyrene triblock copolymer (SEPS), a styrene-ethylene-butylene-styrene block copolymer (SEBS), a polystyrene-poly(ethylene/ethylene-propylene)-polystyrene triblock copolymer (SEEPS), and hydrides thereof.

Examples of the thermoplastic resin constituting thermoplastic resin particles include a polyurethane resin, a polyester resin, a (meth)acrylic resin, a polystyrene resin, a fluororesin, a polyimide resin, a fluorinated polyimide resin, a polyamide resin, a polyamideimide resin, a polyether imide resin, a cellulose acylate resin, a polyether ether ketone resin, a polycarbonate resin, a polyolefin resin (for example, a polyethylene resin, a polypropylene resin, a resin consisting of a cyclic olefin copolymer, and an alicyclic polyolefin resin), a polyarylate resin, a polyether sulfone resin, a polysulfone resin, a fluorene ring-modified polycarbonate resin, an alicyclic ring-modified polycarbonate resin, and a fluorene ring-modified polyester resin.

From the viewpoint of dielectric loss tangent of the film, laser processing suitability, and level difference followability, it is preferable that the thermoplastic particles contain at least one of a resin having a constitutional unit having an aromatic hydrocarbon group or an elastomer having a constitutional unit having an aromatic hydrocarbon group.

Examples of the constitutional unit having an aromatic hydrocarbon group include a phenylethylene group and a butylene terephthalate group.

From the viewpoint of dielectric loss tangent of the film, laser processing suitability, and level difference followability, the thermoplastic particles more preferably contain a polystyrene-based elastomer, still more preferably contain a hydrogenated polystyrene-based elastomer, and even still more preferably contain a hydrogenated styrene-ethylene-butylene-styrene block copolymer.

From the viewpoint of dielectric loss tangent of the film, laser processing suitability, and level difference followability, a content of the thermoplastic particles is preferably 50% by mass or more, more preferably 50% by mass to 95% by mass, and still more preferably 60% by mass to 85% by mass with respect to the total mass of the solid content contained in the first composition.

The first composition may contain only one kind of thermoplastic particles or may contain two or more kinds thereof.

### —Aromatic Polyester Resin—

It is preferable that the first composition contains a liquid crystal polymer. The aromatic polyester resin is preferably a polymer (liquid crystal polymer) exhibiting liquid crystallinity. The liquid crystalline aromatic polyester resin may be a thermotropic liquid crystal polymer or a lyotropic liquid crystal polymer. In addition, in a case of a thermotropic liquid crystal polymer, a liquid crystal polymer that is melted at a temperature of 450° C. or lower is preferable.

The aromatic polyester resin preferably includes one or more selected from an aromatic polyester, an aromatic polyester amide in which an amide bond is introduced into an aromatic polyester, an aromatic polyester ether in which an ether bond is introduced into an aromatic polyester, and an aromatic polyester carbonate in which a carbonate bond is introduced into an aromatic polyester, and more preferably includes an aromatic polyester amide.

In a case where the aromatic polyester resin contains an aromatic polyester amide, from the viewpoint of the flexibility of the product, the content of the aromatic polyester amide with respect to the total mass of the aromatic polyester resin is preferably 50% by mass or more, more preferably 70% by mass or more, still more preferably 90% by mass or more, particularly preferably 95% by mass or more, and most preferably 100% by mass.

Examples of the aromatic polyester resin include the following liquid crystal polymers.
1) a liquid crystal polymer obtained by polycondensing (i) an aromatic hydroxycarboxylic acid, (ii) an aromatic dicarboxylic acid, and (iii) at least one compound selected from the group consisting of an aromatic diol, an aromatic hydroxyamine, and an aromatic diamine;
2) a liquid crystal polymer obtained by polycondensing a plurality of types of aromatic hydroxycarboxylic acids;
3) a liquid crystal polymer obtained by polycondensing (i) an aromatic dicarboxylic acid and (ii) at least one compound selected from the group consisting of an aromatic diol, an aromatic hydroxyamine, and an aromatic diamine;
4) a liquid crystal polymer obtained by polycondensing (i) polyester such as polyethylene terephthalate and (ii) an aromatic hydroxycarboxylic acid.

Here, the aromatic hydroxycarboxylic acid, the aromatic dicarboxylic acid, the aromatic diol, the aromatic hydroxyamine, and the aromatic diamine may be each independently replaced with a polycondensable derivative.

For example, the aromatic hydroxycarboxylic acid and the aromatic dicarboxylic acid can be replaced with aromatic hydroxycarboxylic acid ester and aromatic dicarboxylic acid ester, by converting a carboxy group into an alkoxycarbonyl group or an aryloxycarbonyl group.

The aromatic hydroxycarboxylic acid and the aromatic dicarboxylic acid can be replaced with aromatic hydroxycarboxylic acid halide and aromatic dicarboxylic acid halide, by converting a carboxy group into a haloformyl group.

The aromatic hydroxycarboxylic acid and the aromatic dicarboxylic acid can be replaced with aromatic hydroxycarboxylic acid anhydride and aromatic dicarboxylic acid anhydride, by converting a carboxy group into an acyloxycarbonyl group.

Examples of a polymerizable derivative of a compound having a hydroxy group, such as an aromatic hydroxycarboxylic acid, an aromatic diol, and an aromatic hydroxyamine, include a derivative (acylated product) obtained by acylating a hydroxy group and converting the acylated hydroxy group into an acyloxy group.

For example, the aromatic hydroxycarboxylic acid, the aromatic diol, and the aromatic hydroxyamine can be each replaced with an acylated product by acylating a hydroxy group and converting the acylated hydroxy group into an acyloxy group.

Examples of a polymerizable derivative of a compound having an amino group, such as an aromatic hydroxyamine or an aromatic diamine, include a derivative (acylated product) obtained by acylating an amino group and converting the acylated amino group to an acylamino group.

For example, the aromatic hydroxyamine and the aromatic diamine can be each replaced with an acylated product by acylating an amino group and converting the acylated amino group into an acylamino group.

From the viewpoint of liquid crystallinity, dielectric loss tangent of the film, and adhesiveness to the metal, the aromatic polyester resin preferably has a constitutional unit represented by any of Formulae (1) to (3) (hereinafter, a constitutional unit represented by Formula (1) or the like may be referred to as a constitutional unit (1) or the like), more preferably has a constitutional unit represented by Formula (1), and particularly preferably has a constitutional unit represented by Formula (1), a constitutional unit represented by Formula (2), and a constitutional unit represented by Formula (3).

—O—Ar¹—CO— Formula (1)

—CO—Ar²—CO— Formula (2)

—X—Ar³—Y— Formula (3)

In Formulae (1) to (3), Ar¹ represents a phenylene group, a naphthylene group, or a biphenylylene group, Ar² and Ar³ each independently represent a phenylene group, a naphthylene group, a biphenylylene group, or a group represented by Formula (4), X and Y each independently represent an oxygen atom or an imino group, and hydrogen atoms in Ar¹ to Ar³ may be each independently substituted with a halogen atom, an alkyl group, or an aryl group.

—Ar⁴—Z—Ar⁵— Formula (4)

In Formula (4), Ar⁴ and Ar⁵ each independently represent a phenylene group or a naphthylene group, and Z represents an oxygen atom, a sulfur atom, a carbonyl group, a sulfonyl group, or an alkylene group.

Examples of the halogen atom include a fluorine atom, a chlorine atom, a bromine atom, and an iodine atom.

Examples of the alkyl group include a methyl group, an ethyl group, an n-propyl group, an isopropyl group, an n-butyl group, an isobutyl group, an s-butyl group, a t-butyl group, an n-hexyl group, a 2-ethylhexyl group, an n-octyl group, and an n-decyl group. The number of carbon atoms in the alkyl group is preferably 1 to 10.

Examples of the aryl group include a phenyl group, an o-tolyl group, an m-tolyl group, a p-tolyl group, a 1-naphthyl group, and a 2-naphthyl group. The number of carbon atoms in the aryl group is preferably 6 to 20.

In a case where the hydrogen atom is substituted with any of these groups, the number of each of substitutions in Ar¹, Ar², and Ar³ independently is preferably 2 or less and more preferably 1.

Examples of the alkylene group include a methylene group, a 1,1-ethanediyl group, a 1-methyl-1,1-ethanediyl group, a 1,1-butanediyl group, and a 2-ethyl-1,1-hexanediyl group. The number of carbon atoms in the alkylene group is preferably 1 to 10.

The constitutional unit (1) is a constitutional unit derived from an aromatic hydroxycarboxylic acid.

As the constitutional unit (1), an aspect in which Ar¹ represents a p-phenylene group (constitutional unit derived from p-hydroxybenzoic acid), an aspect in which Ar¹ represents a 2,6-naphthylene group (constitutional unit derived from 6-hydroxy-2-naphthoic acid), or an aspect in which Ar¹ represents a 4,4′-biphenylylene group (constitutional unit derived from 4′-hydroxy-4-biphenylcarboxylic acid) is preferable.

The constitutional unit (2) is a constitutional unit derived from an aromatic dicarboxylic acid.

As the constitutional unit (2), an aspect in which Ar² represents a p-phenylene group (constitutional unit derived from terephthalic acid), an aspect in which Ar² represents an m-phenylene group (constitutional unit derived from isophthalic acid), an aspect in which Ar² represents a 2,6-naphthylene group (constitutional unit derived from 2,6-naphthalenedicarboxylic acid), or an aspect in which Ar² represents a diphenylether-4,4′-diyl group (constitutional unit derived from diphenylether-4,4′-dicarboxylic acid) is preferable.

The constitutional unit (3) is a constitutional unit derived from an aromatic diol, an aromatic hydroxylamine, or an aromatic diamine.

As the constitutional unit (3), an aspect in which Ar³ represents a p-phenylene group (constitutional unit derived from hydroquinone, p-aminophenol, or p-phenylenediamine), an aspect in which Ar³ represents an m-phenylene group (constitutional unit derived from isophthalic acid), or an aspect in which Ar³ represents a 4,4′-biphenylylene group (constitutional unit derived from 4,4′-dihydroxybiphenyl, 4-amino-4′-hydroxybiphenyl, or 4,4′-diaminobiphenyl) is preferable.

A content of the constitutional unit (1) is preferably 30 mol % or more, more preferably 30 mol % to 80 mol %, still more preferably 30 mol % to 60 mol %, and particularly preferably 30 mol % to 40 mol % with respect to the total amount of all constitutional units [that is, a value obtained by dividing the mass of each constitutional unit (also referred to as “monomer unit”) constituting the aromatic polyester resin by the formula weight of each constitutional unit to calculate an amount (mole) equivalent to the substance amount of each constitutional unit and adding up the amounts].

The content of the constitutional unit (2) is preferably 35 mol % or less, more preferably 10 mol % to 35 mol %, still more preferably 20 mol % to 35 mol %, and particularly preferably 30 mol % to 35 mol % with respect to the total amount of all constitutional units.

The content of the constitutional unit (3) is preferably 35 mol % or less, more preferably 10 mol % to 35 mol %, still more preferably 20 mol % to 35 mol %, and particularly preferably 30 mol % to 35 mol % with respect to the total amount of all constitutional units.

The higher the content of the constitutional unit (1), the more easily the heat resistance, strength, and rigidity of the aromatic polyester resin are improved, but the solubility in a solvent is likely to be lowered in a case where the content is too high.

A proportion of the content of the constitutional unit (2) to the content of the constitutional unit (3) is expressed as [content of constitutional unit (2)]/[content of constitutional unit (3)] (mol/mol), and is preferably 0.9/1 to 1/0.9, more preferably 0.95/1 to 1/0.95, and still more preferably 0.98/1 to 1/0.98.

The aromatic polyester resin may each independently have two or more kinds of the constitutional units (1) to (3). In addition, the aromatic polyester resin may have a constitutional unit other than the constitutional units (1) to (3), but the content thereof is preferably 10 mol % or less and more preferably 5 mol % or less with respect to the total amount of all the constitutional units.

From the viewpoint of solubility in a solvent, the aromatic polyester resin preferably has, as the constitutional unit (3), a constitutional unit (3) in which at least one of X or Y is an imino group, that is, preferably has as the constitutional unit (3), at least one of a constitutional unit derived from an aromatic hydroxylamine or a constitutional unit derived from an aromatic diamine, and it is more preferable to have only a constitutional unit (3) in which at least one of X or Y is an imino group.

The aromatic polyester resin is preferably produced by melt-polymerizing raw material monomers corresponding to the constitutional units constituting the aromatic polyester resin. The melt polymerization may be carried out in the presence of a catalyst. Examples of the catalyst include metal compounds such as magnesium acetate, stannous acetate, tetrabutyl titanate, lead acetate, sodium acetate, potassium acetate, and antimony trioxide, and nitrogen-containing heterocyclic compounds such as 4-(dimethylamino)pyridine and 1-methylimidazole; and preferred examples thereof include nitrogen-containing heterocyclic compounds. In a case of being manufactured by melt polymerization of the aromatic polyester resin, the polymer obtained by the melt polymerization may be further subjected to solid-state polymerization as necessary.

The lower limit value of the flow start temperature of the aromatic polyester resin is preferably 180° C. or higher, more preferably 200° C. or higher, and still more preferably 250° C. or higher, and the upper limit value of the flow start temperature is preferably 350° C., more preferably 330° C., and still more preferably 310° C. In a case where the flow start temperature of the aromatic polyester resin is within the above-described range, solubility, heat resistance, strength, and rigidity are excellent, and the viscosity of the solution is appropriate.

The flow start temperature, also referred to as a flow temperature, is a temperature at which a viscosity of 4,800 Pa·s (48,000 poises) is exhibited in a case where the liquid crystal polymer is melted and extruded from a nozzle having an inner diameter of 1 mm and a length of 10 mm while the temperature is raised at a rate of 4° C./min under a load of 9.8 MPa (100 kg/cm²) using a capillary rheometer and is a guideline for the molecular weight of the liquid crystal polymer (see p. 95 of “Liquid Crystal Polymers-Synthesis/Molding/Applications—”, written by Naoyuki Koide, CMC Corporation, Jun. 5, 1987).

In addition, the weight-average molecular weight of the aromatic polyester resin is preferably 1,000,000 or less, more preferably 3,000 to 300,000, still more preferably 5,000 to 100,000, and particularly preferably 5,000 to 30,000. In a case where the weight-average molecular weight of the aromatic polyester resin is in the above-described range, the film after the heat treatment has excellent thermal conductivity, heat resistance, strength, and rigidity in the thickness direction.

The aromatic polyester resin is preferably a polymer soluble in a specific organic solvent (hereinafter, also referred to as a “soluble polymer”).

Specifically, the soluble polymer is a polymer that is preferably dissolved in 0.1 g or more (that is, the solubility in the solvent is 0.1% by mass or more), more preferably in 0.5 g or more (the solubility in the solvent is 0.5% by mass or more), and still more preferably in 1.0 g or more (the solubility in the solvent is 1% by mass or more) at 25° C. in 100 g of at least one solvent (preferably N-methylpyrrolidone) selected from the group consisting of N-methylpyrrolidone, N-ethylpyrrolidone, dichloromethane, dichloroethane, chloroform, N,N-dimethylacetamide, γ-butyrolactone, dimethylformamide, ethylene glycol monobutyl ether, and ethylene glycol monoethyl ether.

From the viewpoint of dielectric loss tangent of the film, laser processing suitability, and level difference followability, a content of the aromatic polyester resin with respect to the total mass of the solid content contained in the first composition is preferably less than 50% by mass, more preferably 5% by mass to 50% by mass, and still more preferably 15% by mass to 40% by mass.

The first composition may contain only one or two or more kinds of aromatic polyester resins.

### —Solvent—

Examples of the solvent contained in the first composition include halogenated hydrocarbons such as dichloromethane, chloroform, 1,1-dichloroethane, 1,2-dichloroethane, 1,1,2,2-tetrachloroethane, 1-chlorobutane, chlorobenzene, and o-dichlorobenzene; halogenated phenols such as p-chlorophenol, pentachlorophenol, and pentafluorophenol; ethers such as diethyl ether, tetrahydrofuran, and 1,4-dioxane; ketones such as acetone and cyclohexanone; esters such as ethyl acetate and γ-butyrolactone; carbonates such as ethylene carbonate and propylene carbonate; amines such as triethylamine; nitrogen-containing heterocyclic aromatic compounds such as pyridine; nitriles such as acetonitrile and succinonitrile; amides such as N,N-dimethylformamide, N,N-dimethylacetamide, and N-methylpyrrolidone; urea compounds such as tetramethylurea; nitro compounds such as nitromethane and nitrobenzene; sulfur compounds such as dimethyl sulfoxide and sulfolane; and phosphorus compounds such as hexamethylphosphoramide and tri-n-butyl phosphate. Among these, two or more kinds thereof may be used in combination.

The above-described solvent preferably contains an aprotic compound (particularly preferably, an aprotic compound having no halogen atom) for low corrosiveness and easiness to handle. A proportion of the aprotic compound to the whole solvent is preferably 50% by mass to 100% by mass, more preferably 70% by mass to 100% by mass, and particularly preferably 90% by mass to 100% by mass. In addition, as the above-described aprotic compound, from the viewpoint of easily dissolving the liquid crystal polymer, an amide such as N,N-dimethylformamide, N,N-dimethylacetamide, tetramethylurea, or N-methylpyrrolidone, or an ester such as γ-butyrolactone is preferable, N,N-dimethylformamide, N,N-dimethylacetamide, or N-methylpyrrolidone is more preferable, and N-methylpyrrolidone is still more preferable.

In addition, as the solvent, it is preferable to contain a compound having a dipole moment of 3 to 5, because the above-described polymer such as the liquid crystal polymer can be easily dissolved. A proportion of the compound having a dipole moment of 3 to 5 to the whole solvent is preferably 50% by mass to 100% by mass, more preferably 70% by mass to 100% by mass, and particularly preferably 90% by mass to 100% by mass.

It is preferable to use the compound having a dipole moment of 3 to 5 as the above-described aprotic compound.

In addition, the solvent preferably contains a compound having a boiling point of 220° C. or lower at 1 atm, since the solvent can be easily removed as necessary. The proportion of the compound having a boiling point of 220° C. or lower at 1 atm in the entire solvent contained in the first composition is preferably 50% by mass to 100% by mass, more preferably 70% by mass to 100% by mass, and particularly preferably 90% by mass to 100% by mass.

It is preferable to use the compound having a boiling point of 220° C. or lower at 1 atm as the above-described aprotic compound.

From the viewpoint of leveling properties during coating and volatility during drying, the content of the solvent with respect to the total mass of the first composition is preferably 50% by mass to 95% by mass, and more preferably 70% by mass to 90% by mass.

The first composition may contain only one kind of solvent or may contain two or more kinds of solvents.

### —Other Additives and Other Resins—

The first composition may or may not include components (other additives) other than the above-described components.

Examples of the other components include an organic filler described later, an inorganic filler described later, a surfactant, a matting agent, a curing agent, a leveling agent, an antifoaming agent, an antioxidant, an ultraviolet absorber, a flame retardant, and a colorant.

In addition, the first composition may or may not include a resin (other resins) other than the aromatic polyester resin. As the other resins, known resins in the related art can be used, and examples thereof include a non-aromatic polyester resin, a fluorine-based resin, a polyolefin resin, a polyamide resin, a polyimide resin, and a phenol resin.

### (Composition According to Second Aspect)

A composition according to a second aspect (hereinafter, also referred to as a second composition) contains thermoplastic particles, an aromatic polyester resin, and a solvent, in which a content of the thermoplastic particles is 50% by mass or more with respect to a total mass of solid contents contained in the composition.

From the viewpoint of dielectric loss tangent of the film, laser processing suitability, and level difference followability, a content of the thermoplastic particles is preferably 50% by mass to 95% by mass, and more preferably 60% by mass to 85% by mass with respect to the total mass of the solid content contained in the second composition.

From the viewpoint of dielectric loss tangent of the film, laser processing suitability, and level difference followability, a ratio of an average particle diameter of the thermoplastic particles contained in the second composition to a thickness of a layer formed by the following method using the second composition (average particle diameter of thermoplastic particles/thickness of layer) is preferably 1.5 or less, more preferably 1.5 to 0.1, still more preferably 1 to 0.1, and particularly preferably 0.7 to 0.1.

Method of forming layer: the second composition is applied to the surface of the copper base material at a coating amount of 0.015 g/cm², and the copper base material is heated in an environment of 180° C. for 300 minutes to form a layer.

From the viewpoint of coating properties and suppression of sedimentation of the thermoplastic particles, the viscosity of the second composition is preferably 50 mPa·s to 2,000 mPa·s, more preferably 100 mPa·s to 1,000 mPa·s, and still more preferably 200 mPa·s to 400 mPa·s.

From the viewpoint of dielectric loss tangent of the film, laser processing suitability, and level difference followability, the average particle diameter of the thermoplastic particles is preferably 100 μm or less, more preferably 1 μm to 100 μm, still more preferably 1 μm to 60 μm, particularly preferably 5 μm to 50 μm, most preferably 10 μm to 30 μm, and may be 10 μm to 20 μm.

Since the preferred aspects of the thermoplastic particles, the aromatic polyester resin, and the solvent are the same as those of the first composition, the description thereof will be omitted here.

In addition, the second composition may or may not include other resins and other additives. Since the resins are the same as those for the first composition, the description thereof will be omitted here.

The second composition may contain only one kind of each component or may contain two or more kinds thereof.

### (Film)

The film according to the embodiment of the present disclosure includes a layer A, and a layer B on at least one surface of the layer A, in which the layer B contains particles (hereinafter, referred to as specific particles) containing at least one of a resin having a constitutional unit having an aromatic hydrocarbon group or an elastomer having a constitutional unit having an aromatic hydrocarbon group, and an aromatic polyester resin, and a minimum area ratio of the specific particles in a cross section of the layer B in a thickness direction is 50% or more.

The film according to the embodiment of the present disclosure has excellent level difference followability and excellent laser processing suitability. The reason why the above-described effect is exhibited is not clear, but is presumed as follows.

In the layer B included in the film according to the embodiment of the present disclosure, the minimum area ratio of the specific particles in the cross section in the thickness direction is 50% or more, and the dispersibility of the specific particles in the layer B is high. As a result, it is presumed that the elastic modulus of the layer B is uniformly lowered during the hot pressing, and the layer B follows the copper wiring pattern, so that the level difference followability is improved.

In addition, since the specific particles have high dispersibility, it is presumed that the specific particles are not locally present in the layer B or are present in a very small amount, and thus the excessive cutting during laser processing caused by the uneven distribution of the specific particles is suppressed, which improves the laser processing suitability.

### <Minimum Area Ratio>

The minimum area ratio of the specific particles in the cross section of the layer B in the thickness direction is preferably 50% to 90%, more preferably 60% to 85%, and still more preferably 70% to 80%.

In the present disclosure, the minimum area ratio is measured as follows.

First, a cross section of the film is observed with an optical microscope to obtain an optical microscope image.

Next, the optical microscope image is subjected to a binarization treatment to visualize the distribution of the aromatic polyester resin and the specific particles contained in the layer B.

In the layer B, the area proportion of the specific particles to a unit area (for example, in a case where the thickness of the layer B is 30 μm, 400 μm² (20 μm×20 μm)) having one side of ⅔ of the film thickness is obtained at 10 locations at intervals of 10 μm from the center portion of the layer B.

The area proportion of the specific particles is the smallest among the 10 sites, and the minimum area ratio is defined as the minimum area ratio.

Whether or not the particles contained in the layer B are particles containing a resin having a constitutional unit having an aromatic hydrocarbon group or an elastomer having a constitutional unit having an aromatic hydrocarbon group is determined by element analysis using SEM-EDX (scanning electron microscope-energy dispersive X-ray spectroscopy).

### <Elastic Modulus of Layer A and Layer B at 160° C.>

From the viewpoint of laser processing suitability and level difference followability, the elastic modulus of the layer A of the film according to the embodiment of the present disclosure at 160° C. is preferably 100 MPa to 2,500 MPa, more preferably 200 MPa to 2,000 MPa, still more preferably 300 MPa to 1,500 MPa, and particularly preferably 500 MPa to 1,000 MPa.

From the viewpoint of laser processing suitability and level difference followability, the elastic modulus of the layer B of the film according to the embodiment of the present disclosure at 160° C. is preferably 100 MPa or less, more preferably 10 MPa or less, still more preferably 0.001 MPa to 10 MPa, and particularly preferably 0.5 MPa to 5 MPa.

From the viewpoint of laser processing suitability and level difference followability, a ratio (MD^{A}/MD^{B}) of the elastic modulus MD^{A} of the layer A at 160° C. to the elastic modulus MD^{B} of the layer B at 160° C. in the film according to the embodiment of the present disclosure is preferably 1.2 or more, more preferably 5 to 1,000, still more preferably 10 to 500, and particularly preferably 100 to 400.

The elastic modulus in the present disclosure is measured by the following method.

First, the film or the laminate is cut in cross section with a microtome or the like, and the layer A or the layer B is specified from an image observed with an optical microscope. Next, the elastic modulus of the specified layer A or layer B is measured as an indentation elastic modulus using a nanoindentation method. The indentation elastic modulus is measured by using a microhardness tester (for example, product name “DUH-W201”, manufactured by Shimadzu Corporation) to apply a load at a loading rate of 0.28 mN/sec with a Vickers indenter at 160° C., holding a maximum load of 10 mN for 10 seconds, and then unloading at a loading rate of 0.28 mN/sec.

The elastic modulus of the layer other than the layer A and the layer B is also measured in the same manner.

In addition, in a case of measuring the elastic modulus of each layer in the film or the laminate, an unnecessary layer may be scraped out with a razor or the like to produce a sample for evaluation of only the target layer, which may be used as a measurement sample. In addition, in a case where it is difficult to take out the single film due to a reason such as a thin thickness of the layer, the layer to be measured may be scraped off with a razor or the like, and the obtained powdery substance may be used as a sample for measuring the elastic modulus.

### —Layer A—

The film according to the embodiment of the present disclosure has a layer A.

Further, examples of a method for detecting or determining the layer configuration, the thickness of each layer, and the like in the film include the following methods.

First, a cross-sectional sample of the film is cut out by a microtome, and a layer configuration and a thickness of each layer are determined with an optical microscope. In a case where the determination with an optical microscope is difficult, the determination may be obtained by performing morphological observation with a scanning electron microscope (SEM), or component analysis by a time-of-flight secondary ion mass spectrometry (TOF-SIMS) or the like.

From the viewpoints of the dielectric loss tangent of the film, the laser processing suitability, and the level difference followability, the dielectric loss tangent of the layer A at 28 GHz is preferably 0.01 or less, more preferably 0.005 or less, still more preferably 0.004 or less, and particularly preferably 0.003 or less. The lower limit value is not particularly set, and examples thereof include more than 0.

From the viewpoints of the dielectric loss tangent of the film, the laser processing suitability, and the level difference followability, the layer A in the film according to the embodiment of the present disclosure preferably includes a liquid crystal polymer.

In addition, from the viewpoint of dielectric loss tangent, liquid crystallinity, and thermal expansion coefficient of the film, the liquid crystal polymer is preferably a polymer having an aromatic ring, and more preferably an aromatic polyester resin.

The aromatic polyester resin is as described in the first composition, and the aromatic polyester resin preferably includes an aromatic polyester amide.

The liquid crystal polymer is preferably a polymer (soluble polymer) soluble in a specific organic solvent.

Specifically, the soluble polymer according to the embodiment of the present disclosure is a polymer that is preferably dissolved in 0.1 g or more (that is, the solubility in the solvent is 0.1% by mass or more), more preferably in 0.5 g or more (the solubility in the solvent is 0.5% by mass or more), and still more preferably in 1.0 g or more (the solubility in the solvent is 1% by mass or more) at 25° C. in 100 g of at least one solvent (preferably N-methylpyrrolidone) selected from the group consisting of N-methylpyrrolidone, N-ethylpyrrolidone, dichloromethane, dichloroethane, chloroform, N,N-dimethylacetamide, γ-butyrolactone, dimethylformamide, ethylene glycol monobutyl ether, and ethylene glycol monoethyl ether.

The layer A may contain only one or two or more kinds of the liquid crystal polymers.

From the viewpoint of dielectric loss tangent of the film and adhesiveness to the metal, a content of the liquid crystal polymer with respect to the total mass of the layer A is preferably 10% by mass to 100% by mass, more preferably 15% by mass to 70% by mass, still more preferably 20% by mass to 50% by mass, and particularly preferably 25% by mass to 40% by mass.

The layer A may contain a filler from the viewpoint of a thermal expansion coefficient and adhesiveness to the metal.

The filler may be particulate or fibrous, and may be an inorganic filler or an organic filler. From the viewpoint of dielectric loss tangent of the film, laser processing suitability, and level difference followability, the filler in a case where the layer A contains a filler is preferably an organic filler.

In the film according to the embodiment of the present disclosure, from the viewpoint of the thermal expansion coefficient and the adhesiveness to the metal, the number density of the filler is preferably larger inside the film than the surface of the film.

Here, the surface of the film refers to a surface (surface in contact with air or substrate) of the film outside, and a smaller one of a range of 3 μm in a depth direction from the most surface or a range of 10% or less of the thickness of the entire film from the most surface is defined as the “surface”. The inside of the film refers to a portion other than the surface of the film, that is, a surface (a surface not in contact with air or a substrate) inside the film, and is not limited, but in a range of ±1.5 μm from the center in the thickness direction of the film or in a range of ±5% of the total thickness from the center in the thickness direction of the film, one having a smaller numerical value is defined as “inside”.

As the organic filler, a known organic filler can be used.

Examples of a material of the organic filler include polyethylene, polystyrene, urea-formalin resin, polyester, cellulose, acrylic resin, fluororesin, cured epoxy resin, crosslinked benzoguanamine resin, crosslinked acrylic resin, a liquid crystal polymer, and a material containing two or more kinds of these.

In addition, the organic filler may be a fibrous filler such as a nanofiber or may be hollow resin particles.

Among these, as the organic filler, from the viewpoint of the dielectric loss tangent of the film, the laser processing suitability, and the level difference followability, fluororesin particles, polyester-based resin particles, polyethylene particles, liquid crystal polymer particles, or cellulose-based resin nanofibers are preferable; polytetrafluoroethylene particles, polyethylene particles, or liquid crystal polymer particles are more preferable; and liquid crystal polymer particles are particularly preferable. Here, the liquid crystal polymer particles are not limited, but refer to particles obtained by polymerizing a liquid crystal polymer and crushing the liquid crystal polymer with a crusher or the like to obtain powdery liquid crystal. It is preferable that the average particle diameter of the liquid crystal polymer particles as the organic filler is smaller than the thickness of each layer.

From the viewpoints of the dielectric loss tangent of the film, the laser processing suitability, and the level difference followability, the average particle diameter of the organic filler is preferably 5 nm to 20 μm and more preferably 100 nm to 10 μm.

As the inorganic filler, a known inorganic filler can be used.

Examples of a material of the inorganic filler include BN, Al₂O₃, AlN, TiO₂, SiO₂, barium titanate, strontium titanate, aluminum hydroxide, calcium carbonate, and a material containing two or more of these.

Among these, as the inorganic filler, from the viewpoint of thermal expansion coefficient and adhesiveness to the metal, metal oxide particles or fibers are preferable, silica particles, titania particles, or glass fibers are more preferable, and silica particles or glass fibers are particularly preferable.

The average particle diameter of the inorganic filler is preferably about 20% to about 40% of the thickness of the layer A. As the inorganic filler, for example, an inorganic filler having an average particle diameter of 25%, 30%, or 35% of the thickness of the layer A may be selected. In a case where the particles or fibers as the inorganic filler have a flat shape, the average particle diameter indicates a value measured with reference to the length in the short side direction.

In addition, from the viewpoint of thermal expansion coefficient and adhesiveness to the metal, the average particle diameter of the inorganic filler is preferably 5 nm to 20 μm, more preferably 10 nm to 10 μm, still more preferably 20 nm to 1 μm, and particularly preferably 25 nm to 500 nm.

The layer A may contain only one or two or more kinds of the fillers.

In addition, from the viewpoint of laser processing suitability and adhesiveness to the metal, the content of the filler with respect to the total mass of the layer A is preferably 5% by mass to 90% by mass, more preferably 30% by mass to 85% by mass, still more preferably 50% by mass to 80% by mass, and particularly preferably 60% by mass to 75% by mass.

The layer A may contain other additives. Since the other additives are the same as those of the first composition, the description thereof will be omitted here.

From the viewpoints of the dielectric loss tangent of the film and the adhesiveness to the metal, the average thickness of the layer A is preferably thicker than the average thickness of the layer B.

From the viewpoint of dielectric loss tangent of the film and adhesiveness to the metal, a value of T^{A}/T^{B}, which is a ratio of the average thickness T^{A} of the layer A to the average thickness T^{B} of the layer B, is preferably 0.8 to 10, more preferably 1 to 5, still more preferably more than 1 and 3 or less, and particularly preferably more than 1 and 2 or less.

In addition, the average thickness of the layer A is not particularly limited, but from the viewpoint of dielectric loss tangent of the film and adhesiveness to the metal, the average thickness thereof is preferably 5 μm to 90 μm, more preferably 10 μm to 70 μm, and particularly preferably 15 μm to 60 μm.

A measuring method of the average thickness of each layer in the film according to the embodiment of the present disclosure is as follows.

The thickness of each layer is evaluated by cutting the film with a microtome and observing the cross section with an optical microscope. Three or more sites of the cross-sectional sample are cut out, the thickness is measured at three or more points in each cross section, and the average value thereof is defined as the average thickness.

### —Layer B—

The film according to the embodiment of the present disclosure includes the layer B on at least one surface of the layer A.

From the viewpoints of the dielectric loss tangent of the film, the laser processing suitability, and the level difference followability, the dielectric loss tangent of the layer B at 28 GHz is preferably 0.01 or less, more preferably 0.005 or less, still more preferably 0.004 or less, and particularly preferably 0.003 or less. The lower limit values of both cases are not particularly set, and examples thereof include a value of more than 0.

The layer B contains one or two or more kinds of specific particles. The specific particles include at least one of a resin having a constitutional unit having an aromatic hydrocarbon group or an elastomer having a constitutional unit having an aromatic hydrocarbon group. The aromatic hydrocarbon group is as described in the first composition, and thus the description thereof will be omitted here.

From the viewpoint of dielectric loss tangent of the film, laser processing suitability, and level difference followability, it is preferable that the specific particles include an elastomer having a constitutional unit having an aromatic hydrocarbon group.

In a case where the specific particles include an elastomer having a constitutional unit having an aromatic hydrocarbon group, the content of the elastomer having a constitutional unit having an aromatic hydrocarbon group with respect to the total mass of the specific particles is preferably 50% by mass or more, more preferably 70% by mass or more, still more preferably 90% by mass or more, particularly preferably 95% by mass or more, and most preferably 100% by mass.

The resin having a constitutional unit having an aromatic hydrocarbon group may be a thermoplastic resin. The thermoplastic resin is not limited as long as it has a constitutional unit having an aromatic hydrocarbon group, and examples thereof include the thermoplastic resin described in the first composition.

In addition, the elastomer having a constitutional unit having an aromatic hydrocarbon group is not limited as long as it has a constitutional unit having an aromatic hydrocarbon group, and examples thereof include the elastomer described in the first composition.

From the viewpoint of dielectric loss tangent of the film, laser processing suitability, and level difference followability, the elastomer having a constitutional unit having an aromatic hydrocarbon group is more preferably a polystyrene-based elastomer, more preferably a hydrogenated polystyrene-based elastomer, and still more preferably a hydrogenated styrene-ethylene-butylene-styrene block copolymer.

From the viewpoint of dielectric loss tangent of the film, laser processing suitability, and level difference followability, a content of the specific particles with respect to the total mass of the layer B is preferably 50% by mass or more, more preferably 50% by mass to 95% by mass, and still more preferably 60% by mass to 85% by mass.

The layer B preferably contains a liquid crystal polymer.

The layer B contains one or two or more kinds of aromatic polyester resins. Since the aromatic polyester resin is the same as that of the first composition, the description thereof will be omitted here.

From the viewpoint of dielectric loss tangent of the film, laser processing suitability, and level difference followability, a content of the aromatic polyester resin with respect to the total mass of the layer B is preferably less than 50% by mass, more preferably 5% by mass to 50% by mass, and still more preferably 15% by mass to 40% by mass.

The layer B may or may not contain other additives and other resins. Since the other additives and other resins that the layer B can contain are the same as those of the first composition, the description thereof will be omitted here.

In addition, an average thickness of the layer B is not particularly limited, but from the viewpoints of the dielectric loss tangent of the film, the laser processing suitability, and the level difference followability, the average thickness is preferably 1 μm to 90 μm, more preferably 5 μm to 60 μm, and particularly preferably 10 μm to 40 μm.

The film according to the embodiment of the present disclosure includes the layer B, and thus a film having excellent adhesiveness to the metal can be obtained. For example, in a case where the layer A has a filler, it is presumed that the surface of the film is improved, and the effect of improving the adhesiveness and the like is obtained by providing the layer B on at least one surface of the layer A which has been embrittled by the addition of the filler.

In addition, the layer B is preferably a surface layer (outermost layer). For example, in a case where the film is used as a laminate (laminated plate with a metal layer) having a layer configuration of metal layer/layer A/layer B, another metal layer or laminated plate with a metal layer may be further disposed on the layer B side. In this case, interface destruction between the layer B and another metal layer in the laminate is suppressed, and the adhesiveness to the metal is improved.

In addition, it is preferable that the polymer contained in the layer B contains a polymer having a higher breaking strength (toughness) that the polymer contained in the layer A.

The breaking strength is measured by the following method.

A sample including the polymer to be measured is produced, and using a universal tensile tester “STM T50BP” manufactured by Toyo Baldwin Co., Ltd., a stress against elongation is measured at a tensile rate of 10%/min in an atmosphere of 25° C. and 60% RH to obtain the breaking strength.

### —Layer C—

The film of the embodiment of the present disclosure preferably further includes a layer C, and from the viewpoint of adhesiveness to the metal, more preferably includes the layer A, the layer C, and the layer B in this order.

The layer C is preferably an adhesive layer.

In addition, in a case where a metal layer is present separately from each of the above-described layers, the layer C is preferably a surface layer (outermost layer).

From the viewpoint of dielectric loss tangent of the film and laser processing suitability, the layer C preferably contains a polymer having a dielectric loss tangent of 0.01 or less at 28 GHz.

Examples of the polymer having a dielectric loss tangent of 0.01 or less include thermoplastic resins such as a liquid crystal polymer, a fluorine-based polymer, a polymerized substance of a compound which has a cyclic aliphatic hydrocarbon group and a group having an ethylenically unsaturated bond, polyether ether ketone, polyolefin, polyamide, polyester, polyphenylene sulfide, aromatic polyether ketone, polycarbonate, polyethersulfone, polyphenylene ether and modified products thereof, and polyetherimide; elastomers such as a copolymer of glycidyl methacrylate and polyethylene; and thermosetting resins such as a phenol resin, an epoxy resin, a polyimide resin, and a cyanate resin.

The polymer having a dielectric loss tangent of 0.01 or less may be a liquid crystal polymer. From the viewpoint of dielectric loss tangent, liquid crystallinity, and thermal expansion coefficient of the film, the liquid crystal polymer is preferably a polymer having an aromatic ring, and more preferably an aromatic polyester resin.

From the viewpoint of dielectric loss tangent of the film and adhesiveness to the metal, a content of the polymer having a dielectric loss tangent of 0.01 or less with respect to the total mass of the layer C is preferably 10% by mass to 99% by mass, more preferably 20% by mass to 95% by mass, still more preferably 30% by mass to 90% by mass, and particularly preferably 40% by mass to 80% by mass.

In addition, from the viewpoint of the dielectric loss tangent of the film and the laser processing suitability, the layer C preferably includes a polymer having an aromatic ring, and more preferably includes a polymer having an aromatic ring, and being a resin having an ester bond and an amide bond, and having a dielectric loss tangent of 0.01 or less.

In addition, the layer C preferably contains an epoxy resin since the metal layer and the resin layer (for example, the layer A) are adhered to each other.

The epoxy resin is preferably a crosslinked product of a polyfunctional epoxy compound. The polyfunctional epoxy compound refers to a compound having two or more epoxy groups. The number of epoxy groups in the polyfunctional epoxy compound is preferably 2 to 4.

The layer C may or may not include other additives. Since the other additives which can be included in the layer C are the same as those of the first composition, the description thereof will be omitted here.

From the viewpoint of dielectric loss tangent of the film and adhesiveness to the metal, it is preferable that an average thickness of the layer C is smaller than an average thickness of the layer A.

From the viewpoint of dielectric loss tangent of the film and adhesiveness to the metal, a value of T^{A}/T^{C}, which is a ratio of the average thickness T^{A} of the layer A to an average thickness T^{C} of the layer C, is preferably more than 1, more preferably 2 to 100, still more preferably 2.5 to 20, and particularly preferably 3 to 10.

From the viewpoint of dielectric loss tangent of the film and adhesiveness to the metal, a value of T^{B}/T^{C}, which is a ratio of the average thickness T^{B} of the layer B to the average thickness T^{C} of the layer C, is preferably more than 1, more preferably 2 to 100, still more preferably 2.5 to 20, and particularly preferably 3 to 10.

Further, from the viewpoint of the dielectric loss tangent of the film and the adhesiveness to the metal, the average thickness of the layer C is preferably 0.1 nm to 20 μm, more preferably 0.1 nm to 5 μm, and still more preferably 1 nm to 1 μm.

From the viewpoint of strength and electrical characteristics (characteristic impedance) in a case of being laminated with the metal layer, an average thickness of the film according to the embodiment of the present disclosure is preferably 6 μm to 200 μm, more preferably 12 μm to 100 μm, and particularly preferably 20 μm to 80 μm.

From the viewpoint of dielectric constant, the dielectric loss tangent of the film according to the embodiment of the present disclosure at 28 GHz is preferably 0.008 or less, more preferably 0.005 or less, still more preferably 0.004 or less, and particularly preferably more than 0 and 0.003 or less.

### <Manufacturing Method of Film>

### [Film Formation]

A manufacturing method of the film according to the embodiment of the present disclosure is not particularly limited, and a known method can be referred to.

Suitable examples of the manufacturing method of the film according to the embodiment of the present disclosure include a co-casting method, a multilayer coating method, and a co-extrusion method. Among these, the co-casting method is particularly preferable for formation of a relatively thin film, and the co-extrusion method is particularly preferable for formation of a thick film.

In a case where the film is manufactured by the co-casting method or the multilayer coating method, it is preferable that the co-casting method or the multilayer coating method is performed by using a composition for forming the layer A, a composition for forming the layer B, a composition for forming the layer C, or the like obtained by dissolving or dispersing components of each layer in a solvent.

In addition, in a case where the manufacturing method of the film according to the embodiment of the present disclosure is the co-casting method, the multilayer coating method, the co-extrusion method, or the like described above, a support may be used in the manufacturing method of the film according to the embodiment of the present disclosure. In addition, in a case where the metal layer (metal foil) or the like used in the laminate described later is used as the support, the support may be used as it is without being peeled off.

Examples of the support include a metal drum, a metal band, a glass plate, a resin film, and a metal foil. Among these, a metal drum, a metal band, or a resin film is preferable.

Examples of the resin film include a polyimide (PI) film, and examples of commercially available products thereof include U-PILEX S and U-PILEX R (manufactured by UBE Corporation), KAPTON (manufactured by Du Pont-Toray Co., Ltd.), and IF30, IF70, and LV300 (manufactured by SKC Kolon PI, Inc.).

In addition, the support may have a surface treatment layer formed on the surface so that the support can be easily peeled off. Hard chrome plating, a fluororesin, or the like can be used as the surface treatment layer.

An average thickness of the support is not particularly limited, but is preferably 25 μm or more and 75 μm or less and more preferably 50 μm or more and 75 μm or less.

In addition, a method for removing at least a part of the solvent from a cast or applied film-like composition (a casting film or a coating film) is not particularly limited, and a known drying method can be used.

### [Stretching]

In the film according to the embodiment of the present disclosure, stretching can be combined as appropriate from the viewpoint of controlling molecular alignment and adjusting linear expansion coefficient and mechanical properties. The stretching method is not particularly limited, and a known method can be referred to, and the stretching method may be carried out in a solvent-containing state or in a dry film state. The stretching in the solvent-containing state may be carried out by gripping and stretching the film, or may be carried out by utilizing self-contraction due to drying without stretching. The stretching is particularly effective for the purpose of improving the breaking elongation and the breaking strength, in a case where brittleness of the film is reduced by addition of an inorganic filler or the like.

In addition, the manufacturing method of the film according to the embodiment of the present disclosure may include a step of polymerizing the film by light or heat, as necessary.

A light irradiation means and a heat application means are not particularly limited, and a known light irradiation means such as a metal halide lamp and a known heat application unit such as a heater can be used.

Light irradiation conditions and heat application conditions are not particularly limited, and the polymerization can be carried out at a desired temperature and time and in a known atmosphere.

### [Heat Treatment]

It is preferable that the manufacturing method of the film according to the embodiment of the present disclosure includes a step of subjecting the film to a heat treatment (annealing).

Specifically, from the viewpoint of dielectric loss tangent and peel strength, the heat treatment temperature in the above-described step of heat-treating is preferably 260° C. to 370° C., more preferably 280° C. to 360° C., and still more preferably 300° C. to 350° C. The heat treatment time is preferably 15 minutes to 10 hours and more preferably 30 minutes to 5 hours.

In addition, the manufacturing method of the film according to the embodiment of the present disclosure may include other known steps as necessary.

### <Applications>

The film according to the embodiment of the present disclosure can be used for various applications. Among the various applications, the film can be used suitably as a film for an electronic component such as a printed wiring board and more suitably for a flexible printed circuit board.

The film according to the embodiment of the present disclosure can be used by being attached to a conductive pattern or a circuit wire.

### (Laminate)

The laminate according to the embodiment of the present disclosure may be a laminate in which the film according to the embodiment of the present disclosure is laminated, but is preferably a laminate including the film according to the embodiment of the present disclosure and a metal layer or a metal wire disposed on at least one surface of the film.

In addition, the laminate according to the embodiment of the present disclosure includes a layer A, a layer B, and a metal layer or a metal wire in this order, in which the layer B contains particles (hereinafter, also referred to as specific particles) containing at least one of a resin having a constitutional unit having an aromatic hydrocarbon group or an elastomer having a constitutional unit having an aromatic hydrocarbon group, and an aromatic polyester resin, and a minimum area ratio of the specific particles in a cross section of the layer B in a thickness direction is preferably 50% or more.

In addition, it is preferable that the laminate according to the embodiment of the present disclosure includes the film according to the embodiment of the present disclosure and a metal layer disposed on a surface of the above-described layer B side of the film, and it is more preferable that the metal layer is a copper layer.

The metal layer disposed on the surface of the above-described layer B side is preferably a metal layer disposed on the surface of the above-described layer B.

In addition, it is preferable that the laminate according to the embodiment of the present disclosure includes the film according to the embodiment of the present disclosure in which the layer B, the layer A, and the layer C are provided in this order, a metal layer disposed on a surface of the above-described layer B side of the film, and a metal layer disposed on a surface of the above-described layer C side of the film; and it is more preferable that both of the metal layers are copper layers.

It is preferable that the metal layer disposed on the surface of the above-described layer C side is a metal layer disposed on the surface of the above-described layer C, and it is more preferable that the metal layer disposed on the surface of the above-described layer B side is a metal layer disposed on the surface of the above-described layer B, and the metal layer disposed on the surface of the above-described layer C side is a metal layer disposed on the surface of the above-described layer C.

In addition, the metal layer disposed on the surface of the above-described layer B side and the metal layer disposed on the surface of the above-described layer C side may be a metal layer having the same material, thickness, and shape, or may be metal layers having different materials, thicknesses, and shapes. From the viewpoint of adjusting the characteristic impedance, the metal layer disposed on the surface of the above-described layer B side and the metal layer disposed on the surface of the above-described layer C side may be metal layers having different materials or thicknesses, or a metal layer may be laminated on only one side of the layer B or the layer C.

Furthermore, from the viewpoint of adjusting the characteristic impedance, preferred examples thereof also include an aspect in which a metal layer is laminated on one side of the layer B or the layer C, and another film is laminated on the other side.

A method of attaching the film according to the embodiment of the present disclosure to the metal layer is not particularly limited, and a known laminating method can be used.

In a case where the above-described metal layer is the above-described copper layer, a peel strength between the above-described film and the above-described copper layer is preferably 0.5 kN/m or more, more preferably 0.7 kN/m or more, still more preferably 0.7 kN/m to 2.0 kN/m, and particularly preferably 0.9 kN/m to 1.5 kN/m.

In the present disclosure, the eel strength between the film and the metal layer (for example, the copper layer) is measured by the following method.

A peeling test piece with a width of 1.0 cm is produced from the laminate of the film and the metal layer, the film is fixed to a flat plate with double-sided adhesive tape, and the strength (kN/m) in a case of peeling the film off from the metal layer at a rate of 50 mm/min is measured by the 180° method in conformity with JIS C 5016 (1994).

From the viewpoint of reducing transmission loss of high-frequency signal, a surface roughness Rz of the above-described metal layer on the side in contact with the above-described film is preferably less than 1 μm, more preferably 0.5 μm or less, and particularly preferably 0.3 μm or less.

Since it is preferable that the surface roughness Rz of the above-described metal layer is as small as possible, the lower limit value thereof is not particularly set, but may be, for example, 0 or more.

The “surface roughness Rz” in the present disclosure refers to a value expressed in micrometer, which is the total value of the maximum value of height of peak and the maximum value of depth of valley observed on a roughness curve over the reference length.

In the present disclosure, the surface roughness Rz of the metal layer (for example, the copper layer) is measured by the following method.

Using a noncontact surface/layer cross-sectional shape measurement system VertScan (manufactured by MITSUBISHI CHEMICAL SYSTEMS, Inc.), a square of 465.48 μm in length and 620.64 μm in width is measured to create a roughness curve on the surface of the measurement object (metal layer) and create an average line of the roughness curve. A portion corresponding to the reference length is extracted from the roughness curve. The surface roughness Rz of the measurement object is measured by obtaining the total value of the maximum value of height of peak (that is, height from the average line to summit) and the maximum value of depth of valley (that is, depth from the average line to valley bottom) observed in the extracted roughness curve.

The metal layer is preferably a copper layer. As the copper layer, a rolled copper foil formed by a rolling method, an electrolytic copper foil formed by an electrolytic method, a copper foil formed by a sputtering method, or a copper foil formed by a vapor deposition method is preferable.

An average thickness of the metal layer, preferably the copper layer, is not particularly limited, but is preferably 0.1 nm to 30 μm, more preferably 0.1 μm to 20 μm, and still more preferably 1 μm to 18 μm. The copper foil may be copper foil with a carrier formed on a support (carrier) to be peelable. As the carrier, a known carrier can be used. An average thickness of the carrier is not particularly limited, but is preferably 5 μm to 100 μm and more preferably 10 μm to 50 μm.

In addition, from the viewpoint of further exerting the effects of the present disclosure, the above-described metal layer preferably has a known surface treatment layer (for example, a chemical treatment layer) on the surface of the side in contact with the film to ensure adhesion to the resin. In addition, it is preferable that the above-described interactable group is a group corresponding to the functional group of the compound having a functional group, which is contained in the above-described film, such as an amino group and an epoxy group, and a hydroxy group and an epoxy group.

Examples of the interactable group include a group mentioned as the functional group in the above-described compound having a functional group.

Among these, from the viewpoint of adhesiveness and ease of performing a treatment, a covalent-bondable group is preferable, an amino group or a hydroxy group is more preferable, and an amino group is particularly preferable.

The metal layer in the laminate according to the embodiment of the present disclosure may be a metal layer having a circuit pattern.

It is also preferable that the metal layer in the laminate according to the embodiment of the present disclosure is processed into, for example, a desired circuit pattern by etching to form a flexible printed circuit board. The etching method is not particularly limited, and a known etching method can be used.

### EXAMPLES

Hereinafter, the present disclosure will be described in more detail with reference to examples. The materials, the used amounts, the proportions, the treatment contents, the treatment procedures, and the like described in the following examples can be appropriately changed without departing from the gist of the present disclosure. Therefore, the scope of the present disclosure is not limited to the following specific examples.

In addition, in the present examples, unless otherwise specified, “%” and “part” mean “% by mass” and “part by mass” respectively.

### <<Measurement Method>>

### [Elastic Modulus at 160° C.]

First, the film was cut in cross section with a microtome or the like, and the layer A or the layer B was specified with an optical microscope. Next, the elastic modulus of the specified layer A or layer B was measured as an indentation elastic modulus using a nanoindentation method. The indentation elastic modulus was measured by using a microhardness tester (product name “DUH-W201”, manufactured by Shimadzu Corporation) to apply a load at a loading rate of 0.28 mN/see with a Vickers indenter at 160° C., holding a maximum load of 10 mN for 10 seconds, and then unloading at a loading rate of 0.28 mN/sec.

### PRODUCTION EXAMPLE

A-1: Aromatic polyester amide (liquid crystalline aromatic polyester resin) produced by the production method described below

### —Synthesis of Aromatic Polyester Amide A-1—

940.9 g (5.0 mol) of 6-hydroxy-2-naphthoic acid, 415.3 g (2.5 mol) of isophthalic acid, 377.9 g (2.5 mol) of acetaminophen, 867.8 g (8.4 mol) of acetic anhydride are put in a reactor comprising a stirring device, a torque meter, a nitrogen gas introduction pipe, a thermometer, and a reflux condenser, gas in the reactor is substituted with nitrogen gas, a temperature increases from a room temperature (23° C., the same applies hereinafter) to 140° C. over 60 minutes while stirring under a nitrogen gas flow, and refluxing is performed at 140° C. for three hours.

Next, the temperature increases from 150° C. to 300° C. over five hours while by-produced acetic acid and unreacted acetic anhydride are distilled and is maintained at 300° C. for 30 minutes. Thereafter, a content is taken out from the reactor and is cooled to the room temperature. An obtained solid is ground by a grinder, and powdered aromatic polyester amide Ala is obtained. A flow start temperature of aromatic polyester amide A1a is 193° C. Aromatic polyester amide A1a is fully aromatic polyester amide.

Aromatic polyester amide A1a is subjected to solid-state polymerization by increasing the temperature from the room temperature to 160° C. over two hours and 20 minutes, next increasing the temperature from 160° C. to 180° C. over three hours and 20 minutes, and maintaining the temperature at 180° C. for five hours under a nitrogen atmosphere, and then, is cooled. Next, aromatic polyester amide A1a is pulverized by a pulverizer, and powdered aromatic polyester amide A1b is obtained. A flow start temperature of aromatic polyester amide A1b is 220° C.

The aromatic polyester amide A1b was subjected to solid-state polymerization by increasing the temperature from room temperature to 180° C. over 1 hour and 25 minutes in a nitrogen atmosphere, by increasing the temperature from 180° C. to 255° C. over 6 hours and 40 minutes, and by maintaining the temperature at 255° C. for 5 hours, and then the resultant was cooled, thereby obtaining a powdered aromatic polyester amide A-1.

A flow start temperature of aromatic polyester amide A-1 is 302° C. In addition, a melting point of the aromatic polyester amide A-1 measured by using a differential scanning calorimetry device was 311° C. Solubility of aromatic polyester amide A2 with respect to N-methylpyrrolidone at 140° C. was 1% by mass or more.
a-1: Liquid crystal polymer particles (filler) produced by the production method described below
   —Production of Filler a-1—

1034.99 g (5.5 mol) of 2-hydroxy-6-naphthoic acid, 89.18 g (0.41 mol) of 2,6-naphthalenedicarboxylic acid, 236.06 g (1.42 mol) of terephthalic acid, 341.39 g (1.83 mol) of 4,4-dihydroxybiphenyl, and potassium acetate and magnesium acetate as a catalyst are put in a reactor comprising a stirring device, a torque meter, a nitrogen gas introduction pipe, a thermometer, and a reflux condenser. Gas in the reactor is substituted with nitrogen gas, and then, acetic anhydride (1.08 molar equivalent with respect to a hydroxyl group) is further added. A temperature increases from a room temperature to 150° C. over 15 minutes while stirring under a nitrogen gas flow, and refluxing is performed at 150° C. for two hours.

Next, the temperature increases from 150° C. to 310° C. over five hours while by-produced acetic acid and unreacted acetic anhydride are distilled, and a polymerized substance is taken out and is cooled to the room temperature. An obtained polymerized substance increases in temperature from the room temperature to 295° C. over 14 hours, and is subjected to solid-state polymerization at 295° C. for one hour. After the solid-state polymerization, the mixture was cooled to room temperature over 5 hours to obtain a filler (liquid crystal polymer particles) a-1. The filler a-1 had a median diameter (D50) of 7 μm, a dielectric loss tangent of 0.0007, and a melting point of 334° C.

—Production of Thermoplastic Resin b-1, and Thermoplastic Particles b-2 to b-5 and c-1—
b-1: TAFTEC M1913, manufactured by Asahi Kasei Corporation, a hydrogenated styrene-ethylene-butylene-styrene block copolymer
b-2: pulverized product of TAFTEC M1913 manufactured by Asahi Kasei Corporation, (average particle diameter of 10.0 μm (D50), thermoplastic particles, elastomer particles containing aromatic hydrocarbon group-containing constitutional unit)
b-3: pulverized product of TAFTEC M1913 manufactured by Asahi Kasei Corporation (average particle diameter of 30.0 μm (D50), thermoplastic particles, elastomer particles containing aromatic hydrocarbon group-containing constitutional unit)
b-4: pulverized product of TAFTEC M1913 manufactured by Asahi Kasei Corporation (average particle diameter of 45.0 μm (D50), thermoplastic particles, elastomer particles containing aromatic hydrocarbon group-containing constitutional unit)
b-5: pulverized product of TAFTEC M1913 manufactured by Asahi Kasei Corporation (average particle diameter of 110.0 μm (D50), thermoplastic particles, elastomer particles containing aromatic hydrocarbon group-containing constitutional unit)
c-1: TAFTEC M1911, manufactured by Asahi Kasei Corporation, pulverized product of hydrogenated styrene-ethylene-butylene-styrene block copolymer (average particle diameter of 10.0 μm (D50), thermoplastic particles, elastomer particles containing constitutional unit having aromatic hydrocarbon group)

### Examples 1 to 6 and Comparative Examples 1 and 2

### —Preparation of Coating Liquid for Undercoat Layer—

8 parts of aromatic polyester amide A-1 were added to 92 parts of N-methylpyrrolidone, and the mixture was stirred at 140° C. for 4 hours in a nitrogen atmosphere to obtain an aromatic polyester amide solution A-1 (concentration of solid contents: 8% by mass).

An aminophenol-type epoxy resin (“jER630”, manufactured by Mitsubishi Chemical Corporation., 0.04 parts) was mixed with the aromatic polyester amide solution A-1 (10.0 parts by mass) to prepare an undercoat layer coating liquid.

### —Preparation of Coating Liquid for Layer A—

The aromatic polyester amide A-1 and the filler a-1 shown in Table 1 were mixed at the mass ratio shown in Table 1, N-methylpyrrolidone was added thereto to adjust the concentration of solid contents to 25% by mass, and a coating liquid for a layer A was obtained.

### —Preparation of Coating Liquid for Layer B—

N-methylpyrrolidone was added to the aromatic polyester amide A-1, and the concentration of solid contents was adjusted to 4.8% by mass, thereby obtaining an A-1 solution.

7 parts of the thermoplastic particles shown in Table 1, 55 parts of 1 mmφ Zr beads, and 38 parts of an A-1 solution having a concentration of solid contents of 4.8% by mass were added to a perfluoroalkoxy alkane (PFA) container, and the liquid after preparation was operated for 24 minutes at an acceleration of 95 G with a low-frequency resonance acoustic mixer (Resodyn Acoustic Mixers, Inc.) to prepare a dispersion liquid. The obtained dispersion liquid was filtered through a PET mesh, and 1 mmφ Zr beads were removed to obtain a coating liquid for a layer B.

In Comparative Example 1, toluene was added to the thermoplastic resin b-1, and the concentration of solid contents was adjusted to 20% by mass, thereby obtaining a coating liquid for a layer B.

### —Preparation of Single-Sided Copper-Clad Laminated Plate—

The obtained undercoat layer coating liquid, the coating liquid for the layer A, and the coating liquid for the layer B were fed to a slot die coater equipped with a slide coater, and applied in a three-layer configuration (undercoat layer/layer A/layer B) to a treatment surface of a copper foil (product name “CF-T9DA-SV-18”, average thickness: 18 μm, manufactured by Fukuda Metal Foil & Powder Co., Ltd.) by adjusting the flow rate so that the film thicknesses shown in Table 1 were obtained. The solvent was removed from the coating film by drying at 90° C. for 4 hours. The temperature was further raised from room temperature to 300° C. at 1° C./min in a nitrogen atmosphere, and the heat treatment was performed for 2 hours at that temperature to obtain a polymer film having a copper layer (a single-sided copper-clad laminated plate).

The average thickness of the undercoat layer was 3 μm.

### <<Evaluation>>

The produced films were evaluated by the following methods, and the results are shown in Table 1.

### [Dielectric Loss Tangent]

The dielectric loss tangent was measured by a resonance perturbation method at a frequency of 10 GHz. A 10 GHz cavity resonator (CP531 manufactured by KANTO Electronic Application and Development Inc.) is connected to a network analyzer (“E8363B” manufactured by Agilent Technology Co., Ltd.), the test piece is inserted into the cavity resonator, and the dielectric loss tangent of the film is measured from change in resonance frequency before and after insertion for 96 hours under an environment of a temperature of 25° C. and humidity of 60% RH.

### [Minimum Area Ratio of Thermoplastic Particles in Cross Section of Layer b in Thickness Direction]

The produced single-sided copper-clad laminated plate was cut along the thickness direction with a cross-sectional polisher (manufactured by JEOL Ltd.), and the cross section was observed with an optical microscope. The obtained optical microscope image was subjected to a binarization treatment to visualize the distribution of the polymer A-1 and the thermoplastic particles.

In the layer B, the area proportion of the thermoplastic particles to a unit area (for example, in Example 1, 20 μm×20 μm) having one side of ⅔ of the film thickness was obtained at 10 locations at intervals of 10 μm from the center portion of the layer B. Among the 10 locations, the location where the area proportion of the thermoplastic particles was the smallest was defined as the minimum area ratio and summarized in Table 1.

### [Level Difference Followability (Wiring Line Followability)]

### (1) Production of Sample

—Production of Base Material A with Wiring Patterns—

A copper foil (product name “CF-T9DA-SV-18”, average thickness of 18 μm, manufactured by Fukuda Metal Foil & Powder Co., Ltd.) and a liquid crystal polymer film (product name “CTQ-50”, average thickness of 50 μm, manufactured by Kuraray Co., Ltd.) as a base material were produced. The copper foil, the base material, and the copper foil were laminated in this order such that the treated surface of the copper foil was in contact with the base material. A double-sided copper-clad laminated plate precursor was obtained by performing a laminating treatment for 1 minute under conditions of 140° C. and a laminating pressure of 0.4 MPa using a laminator (product name “Vacuum Laminator V-130”, manufactured by Nikko-Materials Co., Ltd.). Subsequently, using a thermal compression machine (product name “MP-SNL”, manufactured by Toyo Seiki Seisaku-sho, Ltd.), the obtained double-sided copper-clad laminated plate precursor was thermally compression-bonded for 10 minutes under conditions of 300° C. and 4.5 MPa to prepare a double-sided copper-clad laminated plate.

The copper foils on both surfaces of the above-described double-sided copper-clad laminated plate were roughened, and a dry film resist was bonded thereto. The exposure and development were performed such that the wiring patterns remained, etching was performed, and the dry film was further removed to produce a base material with wiring patterns in which the line/space including the ground line and the three pairs of signal lines on both sides of the base material was 100 μm/100 μm. A length of the signal line was 50 mm, and a width of the signal line was set such that characteristic impedance was 50Ω.

—Production of Base Material B with Wiring Pattern—

A copper foil (product name “MT18FL”, average thickness: 1.5 μm, with carrier copper foil (thickness: 18 μm), manufactured by Mitsui Mining & Smelting Co., Ltd.) and a liquid crystal polymer film (product name “CTQ-50”, average thickness: 50 μm, manufactured by Kuraray Co., Ltd.) as a base material were produced. The copper foil, the base material, and the copper foil were laminated in this order such that the treated surface of the copper foil was in contact with the base material. A single-sided copper-clad laminated plate precursor was obtained by performing a laminating treatment for 1 minute under conditions of 140° C. and a laminating pressure of 0.4 MPa using a laminator (product name “Vacuum Laminator V-130”, manufactured by Nikko-Materials Co., Ltd.). Subsequently, using a thermal compression machine (product name “MP-SNL”, manufactured by Toyo Seiki Seisaku-sho, Ltd.), the obtained precursor of the single-sided copper-clad laminated plate was thermally compression-bonded for 10 minutes under the conditions of 300° C. and 4.5 MPa to prepare a single-sided copper-clad laminated plate. The carrier copper foil on the surface of the single-sided copper-clad laminated plate opposite to the base material was peeled off, the exposed 1.5 μm copper foil was roughened, and a dry film resist was bonded thereto. The resist was subjected to pattern exposure in a wiring shape and development through a dry film resist, and a region where the resist pattern was not disposed was subjected to a plating treatment. Further, the dry film resist was peeled off, and copper exposed in the peeling step was removed by flash etching to produce a base material with wiring patterns having a line/space of 20 μm/20 μm.

### —Production of Wiring Board—

The base material with wiring patterns produced above was overlaid on the layer B side of the produced single-sided copper-clad laminated plate, and a hot press was performed for 1 hour under the conditions of 160° C. and 4 MPa to obtain a wiring board.

In the obtained wiring board, wiring patterns (a ground line and a signal line) were buried, and in a case where the base material A with wiring patterns was used, the thickness of the wiring patterns was 18 μm, and in a case where the base material B with wiring patterns was used, the thickness of the wiring patterns was 12 μm.

### (2) Measuring Method

The wiring board was cut along the thickness direction with a microtome, and a cross section was observed with an optical microscope. A length L of a gap generated between the resin layer and the wiring pattern in an in-plane direction was measured. The average value of the results at 10 points was calculated. The evaluation standards are as follows.
A: L is less than 2 μm.
B: L is 2 μm or more.

### [Laser Processing Suitability]

### (1) Production of Sample

Among the prepared single-sided copper-clad laminated plates, the single-sided copper-clad laminated plate in which the copper foil was laminated was subjected to electrolytic copper plating to have a copper foil thickness of 18 μm. Furthermore, a copper foil (product name “CF-T9DA-SV-18”, average thickness: 18 μm, manufactured by Fukuda Metal Foil & Powder Co., Ltd.) was laminated on the layer B surface side of all the samples such that the treatment surface of the copper foil was in contact with the layer B surface. A double-sided copper-clad laminated plate was obtained by performing a laminating treatment for 60 minutes under conditions of 160° C. and a laminating pressure of 4 MPa using a laminator (product name “Vacuum Laminator V-130”, manufactured by Nikko-Materials Co., Ltd.).

### (2) Measuring Method

Through-hole via holes were processed from the single-sided copper-clad laminated plate side of the double-sided copper-clad laminated plate using a UV-YAG laser Model 5330 manufactured by ESI. The cross section of the via portion was observed with an optical microscope, and the length of peeling of the layer A and the layer B (that is, the maximum length of the recess formed in the cross section of the cut portion in a horizontal direction) was measured.

TABLE 1

| | Layer A | | | | | | | Layer B | |
|---|---|---|---|---|---|---|---|---|---|
| | Aromatic | | | | | Elastic | | Aromatic | |
| | polyester amide | | Filler | | | modulus | | polyester amide | |
| | | Context | | Context | Dielectric | MD [symbol] at | | | Context |
| | | [% by | | [% by | loss | 160° C. | Thickness | | [% by |
| | Type | mass] | Type | mass] | tangent | [MPa] | [μm] | Type | mass] |
| Example 1 | A-1 | 25 | a-1 | 75 | 0.002 | 790 | 20 | A-1 | 20 |
| Example 2 | A-1 | 25 | a-1 | 75 | 0.002 | 790 | 20 | A-1 | 20 |
| Example 3 | A-1 | 25 | a-1 | 75 | 0.002 | 790 | 20 | A-1 | 20 |
| Example 4 | A-1 | 25 | a-1 | 75 | 0.002 | 790 | 20 | A-1 | 20 |
| Example 5 | A-1 | 25 | a-1 | 75 | 0.002 | 790 | 20 | A-1 | 20 |
| Example 6 | A-1 | 25 | a-1 | 75 | 0.002 | 790 | 20 | A-1 | 20 |
| Comparative | A-1 | 25 | a-1 | 75 | 0.002 | 790 | 20 | — | — |
| Example 1 | | | | | | | | | |
| Comparative | A-1 | 25 | a-1 | 75 | 0.002 | 790 | 20 | A-1 | 20 |
| Example 2 | | | | | | | | | |
| | | | | | | | Maximum | | |
| | | | | | | | area ratio of | | |
| | Layer B | | | | | | thermoplastic | | |
| | Thermoplastic particles | | | | Elastic | | particles in | | |
| | | Average | | | modulus | | cross section | | Laser |
| | | particle | Context | Dielectric | MDB at | | of layer B | Level | processing |
| | | diameter | [% by | loss | 160° C. | Thickness | in thickness | difference | suitability |
| | Type | [μm] | mass] | tangent | [MPa] | [μm] | direction | flowability | [μm] |
| Example 1 | b-2 | 10 | 80 | 0.002 | 2.10 | 30 | 80% | A | 5 |
| Example 2 | b-3 | 30 | 80 | 0.002 | 2.15 | 30 | 75% | A | 7.5 |
| Example 3 | b-4 | 45 | 80 | 0.002 | 2.05 | 30 | 70% | A | 10 |
| Example 4 | b-2 | 10 | 50 | 0.002 | 2.10 | 30 | 50% | A | 5 |
| Example 5 | b-2 | 10 | 80 | 0.002 | 2.10 | 50 | 80% | A | 5 |
| Example 6 | c-1 | 10 | 80 | 0.002 | 2.10 | 30 | 80% | A | 5 |
| Comparative | b-1 | — | 100 | 0.002 | 1. [symbol] 0 | 30 | 100% | A | 20 |
| Example 1 | | | | | | | | | |
| Comparative | b-5 | 110 | 80 | 0.002 | 1.90 | 30 | 30% | B | 10 |
| Example 2 | | | | | | | | | |

[symbol]

indicates data missing or illegible when filed

From the results shown in Table 1, the films of Examples 1 to 6, which are the films according to the embodiment of the present disclosure, have excellent level difference followability and excellent laser processing suitability as compared with the films of Comparative Examples 1 and 2.

In addition, from the results shown in Table 1, the films of Examples 1 to 6, which are the films according to the embodiment of the present disclosure, have a low dielectric loss tangent.

The disclosure of JP2022-138489 filed on Aug. 31, 2022 is incorporated herein by reference.

All publications, patent applications, and technical standards mentioned in the present disclosure are herein incorporated by reference to the same extent as if each individual publication, patent application, and technical standard were specifically and individually indicated to be incorporated by reference.

What is claimed is:

1. A composition comprising:
thermoplastic particles having an average particle diameter of 100 μm or less;
an aromatic polyester resin; and
a solvent.

2. The composition according to claim 1,
wherein the thermoplastic particles are elastomer particles.

3. The composition according to claim 1,
wherein the thermoplastic particles contain a resin having a constitutional unit having an aromatic hydrocarbon group or an elastomer including a constitutional unit having an aromatic hydrocarbon group.

4. The composition according to claim 1,
wherein the aromatic polyester resin contains an aromatic polyester amide.

5. The composition according to claim 1,
wherein the solvent contains N-methylpyrrolidone.

6. A composition comprising:
thermoplastic particles;
an aromatic polyester resin; and
a solvent,
wherein a content of the thermoplastic particles is 50% by mass or more with respect to a total mass of solid contents contained in the composition.

7. The composition according to claim 6,
wherein a ratio of an average particle diameter of the thermoplastic particles to a thickness of a layer formed by a method of forming the following layer is 1.5 or less,
method of forming layer: the composition is applied to a surface of a copper base material at a coating amount of 0.015 g/cm², and the composition is heated in an environment of 180° C. for 300 minutes to form a layer.

8. The composition according to claim 6,
wherein the thermoplastic particles are elastomer particles.

9. The composition according to claim 6,
wherein the thermoplastic particles contain a resin having a constitutional unit having an aromatic hydrocarbon group or an elastomer including a constitutional unit having an aromatic hydrocarbon group.

10. The composition according to claim 6,
wherein the aromatic polyester resin contains an aromatic polyester amide.

11. The composition according to claim 6,
wherein the solvent contains N-methylpyrrolidone.

12. A film comprising:
a layer A; and
a layer B on at least one surface of the layer A,
wherein the layer B contains particles containing at least one of a resin having a constitutional unit having an aromatic hydrocarbon group or an elastomer having a constitutional unit having an aromatic hydrocarbon group, and an aromatic polyester resin, and
a minimum area ratio of the particles in a cross section of the layer B in a thickness direction is 50% or more.

13. The film according to claim 12,
wherein a ratio of an elastic modulus of the layer A at 160° C. to an elastic modulus of the layer B at 160° C. is 1.2 or more.

14. The film according to claim 12,
wherein an elastic modulus of the layer B at 160° C. is 10 MPa or less.

15. The film according to claim 12,
wherein a dielectric loss tangent of the layer A at 28 GHz is 0.01 or less.

16. The film according to claim 12,
wherein the layer A contains a liquid crystal polymer.

17. The film according to claim 12,
wherein the layer A contains an aromatic polyester amide.

18. The film according to claim 12,
wherein a dielectric loss tangent of the layer B at 28 GHz is 0.01 or less.

19. The film according to claim 12,
wherein the layer B contains a liquid crystal polymer.

20. The film according to claim 12,
wherein the aromatic polyester resin contains an aromatic polyester amide.
